(19) United States
(12) Patent Application Publication
(10) Pub. No.: US 2016/0311208 A1
(43) Pub. Date: Oct. 27, 2016

(54) FURAN-BASED POLYMERIC HYDROCARBON FUEL BARRIER STRUCTURES

(71) Applicant: E. I. DU PONT DE NEMOURS AND COMPANY, Wilmington, DE (US)

(72) Inventors: Fredrick Nederberg, East Amherst, NY (US); Richard L. Bell, Troy, MI (US); Jose Maria Torradas, West Chester, PA (US)

(21) Appl. No.: 15/105,936

(22) PCT Filed: Dec. 18, 2014
(86) PCT No.: PCT/US14/71069

§ 371 Date: Jun. 17, 2016

Related U.S. Application Data
(60) Provisional application No. 61/918,708, filed on Dec. 20, 2013.

(51) Int. Cl. B32B 27/36; B32B 27/32; C08G 63/672; B60K 15/04; B60K 15/03; B32B 27/08; B32B 27/34

(52) U.S. Cl. CPC B32B 27/36; B32B 27/08; B32B 27/32; B32B 27/34; B60K 15/04; B60K 15/03177; C08G 63/672; B32B 2439/00; B32B 2307/7242; B32B 2307/7265; C08G 2390/40

(57) ABSTRACT

Disclosed herein are multilayer structures and articles comprising the multilayer structures. The multilayer structure comprising a hydrocarbon fuel permeation barrier layer comprising furan-based polyester; a structural layer; and a tie layer interposed between the barrier layer and the structural layer, wherein the multilayer structure provides permeation barrier to the hydrocarbon fuel.

### CROSS-REFERENCE TO RELATED APPLICATIONS

This application claims the benefit of U.S. Provisional Application No. 61/918,708 filed on Dec. 20, 2013, which is incorporated herein by reference in its entirety.

### FIELD OF THE INVENTION

This invention relates in general to furan-based polyesters and, in particular, to hydrocarbon fuel permeation barrier layers comprising furan-based polyester and articles made therefrom for storage or transport of hydrocarbon fuel.

### BACKGROUND INFORMATION

Several incumbent hydrocarbon barrier polymer technologies exist in the marketplace, such as, liquid crystalline polymers, fluoropolymers (for example Tefzel®, ethylenetetrafluoroethylene copolymer (ETFE)) and polyethylene-co-vinylalcohol (EVOH). Other hydrocarbon barrier technologies include laminar technology where platelets of polyamide 6 or EVOH are formed in a HDPE matrix and on-line and off-line fluorination. EVOH, when used as a continuous layer provides a combination of lower cost and good performance and is therefore the most widely used polymer hydrocarbon barrier. However, low content ethylene EVOH (32% or less) has disadvantages, such as brittleness and increased permeation at high moisture content due to the hydrophilicity of the vinyl alcohol group. EVOH is typically used in a multilayered package using HDPE or Nylon as the outer substrates, and EVOH as the middle barrier layer.

Hence, there is a need for new polymers providing permeation barrier to hydrocarbon fuel.

### SUMMARY OF THE INVENTION

In a first embodiment, there is a multilayer structure comprising:
a. a hydrocarbon fuel permeation barrier layer comprising a furan-based polyester, wherein the furan-based polyester is derived from:
   i. 2,5-furan dicarboxylic acid or a derivative thereof,
   ii. a C₂ to C₁₂ aliphatic diol or a polyol, and
   iii. optionally at least one of a polyalkylene ether glycol (PAEG), a polyfunctional acid or a polyfunctional hydroxyl acid;
b. a first structural layer, wherein the first structural layer comprises at least one of a polyolefin, a polyester, or a polyamide; and
c. a first tie layer interposed between the barrier layer and the first structural layer, wherein the first tie layer comprises an ethylene based copolymer,

wherein the hydrocarbon fuel permeation barrier layer has a thickness in the range of 0.5-50% of the total thickness of the multilayer structure to provide a permeation barrier to a hydrocarbon fuel.

In a second embodiment, the multilayer structure further comprises a second structural layer wherein the barrier layer is interposed between the first tie layer and the second structural layer.

In a third embodiment, the multilayer structure further comprises a second tie layer wherein the barrier layer is interposed between the first tie layer and the second tie layer, and wherein the first tie layer comprises an ethylene based copolymer.

In a fourth embodiment of the multilayer structure, the furan-based polyester is poly(trimethylene furandicarboxylate).

In a fifth embodiment of the multilayer structure, the barrier layer further comprises poly(trimethylene furandicarboxylate) (PTF), such that the furan-based polyester is different from PTF and wherein the furan-based polyester and PTF forms a polymer blend comprising 0.1-99.9% by weight of PTF, based on the total weight of the polymer blend composition comprising the furan-based polyester and PTF.

In a sixth embodiment of the multilayer structure, the barrier layer further comprises poly(alkylene terephthalate) (PAT), wherein the furan-based polyester and PAT forms a polymer blend comprising 0.1-99.9% by weight of PAT, based on the total weight of the polymer blend composition comprising the furan-based polyester and PAT.

In a seventh embodiment of the multilayer structure, the barrier layer comprises poly(trimethylene furandicarboxylate) (PTF) and poly(ethylene terephthalate) (PET).

In an eighth embodiment, the multilayer structure is in a form of a housing provided with a port for introducing a hydrocarbon fuel in an enclosure defined by the housing.

In a ninth embodiment, the multilayer structure is in a form of a hollow body selected from a group consisting of a hose, a pipe, a duct, a tube, a tubing or a conduit.

In a tenth embodiment, there is an article for storage or transport of a hydrocarbon fuel comprising the multilayer structure in a form of a housing provided with a port for introducing hydrocarbon fuel in an enclosure defined by the housing, wherein the multilayer structure provides permeation barrier to the hydrocarbon fuel.

In an eleventh embodiment, the article further comprises means for closing the port, such that upon closing the port, the material is isolated from the outside environment.

In a twelfth embodiment of the article, the hydrocarbon fuel comprises one or more of ethanol, methanol, butanol, toluene, xylene, isooctane, gasoline, kerosene, liquefied petroleum, diesel and biodiesel.

In a thirteenth embodiment, the article is in a form selected from the group consisting of a fuel container, a fuel container with a lid, a fuel container with a closure, a fuel canister, a fuel valve, a fuel inlet, a fuel filler neck, a fuel tank and a fuel line.

In a fourteenth embodiment, there is a method of reducing hydrocarbon fuel permeation through a fuel tank comprising providing a fuel tank having at least one polymeric barrier layer, wherein the polymeric barrier layer comprises furan-based polyester, wherein furan-based polyester is derived from:
a) 2,5-furan dicarboxylic acid or a derivative thereof,
b) a C₂ to C₁₂ aliphatic diol or a polyol, and
c) optionally at least one of a polyalkylene ether glycol (PAEG), a polyfunctional acid or a polyfunctional hydroxyl acid.

In a fifteenth embodiment, there is a method of storing or transporting a hydrocarbon fuel comprising providing a housing with a port for introducing the hydrocarbon fuel in an enclosure defined by the housing, wherein the housing comprises furan-based polyester, wherein furan-based polyester is derived from:
a) 2,5-furan dicarboxylic acid or a derivative thereof,
b) a C₂ to C₁₂ aliphatic diol or a polyol, and
c) optionally at least one of a polyalkylene ether glycol (PAEG), a polyfunctional acid or a polyfunctional hydroxyl acid.

### BRIEF DESCRIPTION OF THE DRAWINGS

The invention is illustrated by way of example and not limited to the accompanying figures.

FIG. 1 schematically illustrates a cross-sectional view of a portion of an exemplary multilayer structure comprising three layers, in accordance with the present invention.

FIG. 2 schematically illustrates a cross-sectional view of a portion of an exemplary multilayer structure comprising at least four layers, in accordance with the present invention.

FIG. 3 schematically illustrates a cross-sectional view of a portion of an exemplary multilayer structure comprising at least five layers in accordance with the present invention.

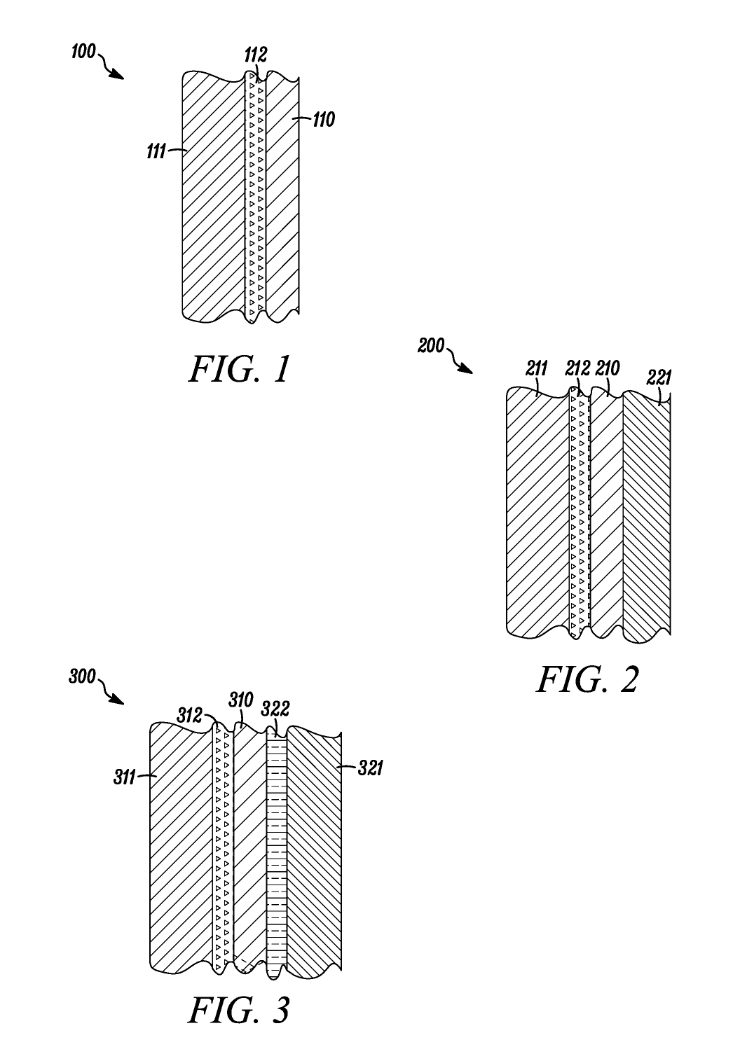

Reference numerals shown in FIGS. 1-3 are explained below:

100, 200, 300: multilayer structure

110, 210, 310: barrier layer

111, 211, 311: first structural layer

221, 321: second structural layer

112, 212, 312: first tie layer

322: second tie layer

### DETAILED DESCRIPTION

The disclosures of all patent and non-patent literature are by herein incorporated by reference in their entireties.

The term “barrier” is used interchangeably with “permeation rate” to describe hydrocarbon fuel barrier properties, with low permeation rate of a hydrocarbon fuel implying that the hydrocarbon fuel has a higher barrier.

The terms “barrier” and “barrier layer”, as applied to multilayer structures, refer to the ability of a structure or layer to serve as a barrier to a fluid (e.g. a gas or a liquid) and in particular, to hydrocarbon fuels.

The term “hydrocarbon fuel permeation barrier layer” is used interchangeably with “barrier layer” and “polymeric barrier layer”.

The term “fuel container” refers to, but is not limited to:
fuel containers mounted on
   automobiles, motor cycles, ships, airplanes, electric generators, lawn tractors snow-mobiles,
   small portable equipment, for example string trimmer, blowers (leaf & snow), pressure washers, mowers, generators, and
   other household, industrial and agricultural machines;
portable containers such as jerry can for supplying fuels to the fuel containers; and also
containers for storing fuels to be used for driving such machines.

The term “tie layer” as used herein refers to polymeric layer that improves the adhesion between the two layers such as between a barrier layer and a structural layer.

The term “furan dicarboxylic acid” is used interchangeably with furan dicarboxylic acid; 2,5-furan dicarboxylic acid; 2,4-furan dicarboxylic acid; 3,4-furan dicarboxylic acid; and 2,3-furan dicarboxylic acid. As used herein, the 2,5-furandicarboxylic acid (FDCA), is also known as dehydromucic acid, is an oxidized furan derivative, as shown below:

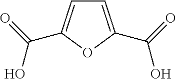 [SMILES: O=C(O)c1ccc(C(=O)O)o1]

The term “furan 2,5-dicarboxylic acid (FDCA) or a functional equivalent thereof” refers to any suitable isomer of furan dicarboxylic acid or derivative thereof such as, 2,5-furan dicarboxylic acid; 2,4-furan dicarboxylic acid; 3,4-furan dicarboxylic acid; 2,3-furan dicarboxylic acid or their derivatives. The terms “PTF” and “poly(trimethylene furandicarboxylate)” are used interchangeably to refer to poly(trimethylene-2,5 furandicarboxylate), poly(trimethylene-2,4 furandicarboxylate), poly(trimethylene-2,3 furandicarboxylate), and poly(trimethylene-3,4 furandicarboxylate).

The term “biologically-derived” is used interchangeably with “bio-derived” and refers to hydrocarbon fuel compounds including monomers and polymers, that are obtained from renewable resources such as plants and contain either only or substantially renewable carbon, and no or a very minimal amount fossil fuel-based or petroleum-based carbon.

Disclosed is a multilayer structure comprising a hydrocarbon fuel permeation barrier layer, a structural layer and a tie layer interposed between the first structural layer and the barrier layer, the barrier layer comprising furan-based polyester, wherein the multilayer structure provides a permeation barrier to a hydrocarbon fuel. In an embodiment, furan-based polyester is derived from polycondensation of 2,5-furan dicarboxylic acid or a derivative thereof, a C₂ to C₁₂ aliphatic diol or a polyol and optionally at least one of a polyalkylene ether glycol (PAEG), a polyfunctional acid or a polyfunctional hydroxyl acid.

FIG. 1 schematically illustrates a cross-sectional view of a portion of an exemplary multilayer structure 100 comprising at least three layers, in accordance with the present disclosure. The multilayer structure 100, as shown in FIG. 1 comprises a hydrocarbon fuel permeation barrier layer 110 comprising furan-based polyester of the present disclosure and a first structural layer 111. The multilayer structure 100 also comprises a first tie layer 112 interposed between the barrier layer 110 and the first structural layer 111.

FIG. 2 schematically illustrates a cross-sectional view of a portion of an exemplary multilayer structure 200 comprising at least four layers, in accordance with the present disclosure. The multilayer structure 200, as shown in FIG. 2 comprises a hydrocarbon fuel permeation barrier layer 210 comprising furan-based polyester of the present disclosure, a first structural layer 211 and a first tie layer 212 interposed between the barrier layer 210 and the first structural layer 211. The multilayer structure 200 also comprises a second structural layer 221, such that the barrier layer 210 is interposed between the first tie layer 212 and the second structural layer 221.

FIG. 3 schematically illustrates a cross-sectional view of a portion of an exemplary multilayer structure 300 comprising at least five layers, in accordance with the present disclosure. The multilayer structure 300, as shown in FIG. 3 comprises a hydrocarbon fuel permeation barrier layer 310 comprising furan-based polyester of the present disclosure, a first structural layer 311 and a first tie layer 312 interposed between the barrier layer 310 and the first structural layer 311. The multilayer structure 300 also comprises a second tie layer 322 interposed between the barrier layer 310 and a second structural layer 321, such that the barrier layer 310 is interposed between the first tie layer 312 and the second tie layer 322.

The multilayer structure of the present invention may comprise other possible layer configurations not illustrated, including, but not limited to six layers, seven layers, eight layers, etc., wherein at least one layer is a barrier layer comprising furan-based polyester of the present disclosure.

In an embodiment of the multilayer structure, the furan-based polyester is poly(trimethylene furandicarboxylate).

Barrier Layer

The barrier layer comprises furan-based polyester obtained by polymerization of a reaction mixture comprising 2,5-furan dicarboxylic acid or a derivative thereof, a C₂ to C₁₂ aliphatic diol or a polyol, and optionally at least one of a polyalkylene ether glycol (PAEG), a polyfunctional acid or a polyfunctional hydroxyl acid. The C₂ to C₁₂ aliphatic diol maybe linear or branched.

In a derivative of 2,5-furan dicarboxylic acid, the hydrogens at the 3 and/or 4 position on the furan ring can, if desired, be replaced, independently of each other, with —CH₃, —C₂H₅, or a C₃ to C₂₅ straight-chain, branched or cyclic alkane group, optionally containing one to three heteroatoms selected from the group consisting of O, N, Si and S, and also optionally substituted with at least one member selected from the group consisting of —Cl, —Br, —F, —I, —OH, —NH₂ and —SH. A derivative of 2,5-furan dicarboxylic acid can also be prepared by substitution of an ester or halide at the location of one or both of the acid moieties.

Examples of suitable C₂-C₁₂ aliphatic diol include, but are not limited to, ethylene glycol; diethylene glycol; 1,2-propanediol; 1,3-propanediol; 1,4-butanediol; 1,5-pentanediol; 1,6-hexanediol; 1,4-cyclohexanedimethanol; and 2,2-dimethyl-1,3-propanediol. In an embodiment, the aliphatic diol is a biologically derived C₃ diol, such as 1,3-propanediol (BioPDO™).

The furan-based polyester of the barrier layer, 110, 210, 310, as shown in FIGS. 1, 2 and 3, can be a copolyester (random or block) derived from furan dicarboxylic acid or a functional equivalent thereof, at least one of a diol or a polyol monomer, and at least one of a polyfunctional aromatic acid or a hydroxyl acid. The molar ratio of furan dicarboxylic acid to at least one of a polyfunctional aromatic acid or a hydroxyl acid can be any range, for example the molar ratio of either component can be greater than 1:100 or alternatively in the range of 1:100 to 100:1 or 1:9 to 9:1 or 1:3 to 3:1 or 1:1 in which the diol is added at an excess of 1.2 to 3 equivalents to total charged acid including furan dicarboxylic acid and at least one of a polyfunctional aromatic acid or a hydroxyl acid).

Examples of suitable polyfunctional acids include but are not limited to terephthalic acid, isophthalic acid, adipic acid, azelic acid, sebacic acid, dodecanoic acid, 1,4-cyclohexane dicarboxylic acid, maleic acid, succinic acid, 2,6-naphthalene dicarboxylic acid, and 1,3,5-benzenetricarboxylic acid.

Examples of suitable hydroxy acids include but are not limited to, glycolic acid, hydroxybutyric acid, hydroxycaproic acid, hydroxyvaleric acid, 7-hydroxyheptanoic acid, 8-hydroxycaproic acid, 9-hydroxynonanoic acid, or lactic acid; or those derived from pivalolactone, ε-caprolactone or L,L, D,D or D,L lactides.

Examples of other diol and polyol monomers that can be included, in addition to the C₂-C₁₂ aliphatic diol named above, in the polymerization monomer makeup from which a furan-based copolyester can be made include, but are not limited to, 1,4-benzenedimethanol, 2,2,4,4-tetramethyl-1,3-cyclobutanediol, cyclohexyldimethanol, poly(ethylene glycol), poly(tetrahydrofuran), 2,5-di(hydroxymethyl)tetrahydrofuran, isosorbide, isomannide, glycerol, pentaerythritol, sorbitol, mannitol, erythritol, and threitol. The molar ratio of C₂-C₁₂ aliphatic diol to the other diols and polyol monomers present in the furan-based copolyesters can be any range, for example the molar ratio of either component can be greater than 1:100 or alternatively in the range of 1:100 to 100:1 or 1:9 to 9:1 or 1:3 to 3:1 or 1:1

Exemplary furan-based polyesters that are copolymers derived from furan dicarboxylic acid, at least one of a diol or a polyol monomer, and at least one of a polyfunctional acid or a hydroxyl acid include, but are not limited to, copolymer of 1,3-propanediol, 2,5-furandicarboxylic acid and terephthalic acid; copolymer of 1,3-propanediol, ethylene glycol and 2,5-furandicarboxylic acid; copolymer of 1,3-propanediol, 1,4-butanediol and 2,5-furandicarboxylic acid; copolymer of 1,3-propanediol, 2,5-furandicarboxylic acid and succinic acid; copolymer of 1,3-propanediol, 2,5-furandicarboxylic acid; copolymer of 1,3-propanediol, 2,5-furandicarboxylic acid and adipic acid; copolymer of 1,3-propanediol, 2,5-furandicarboxylic acid and sebacic acid, copolymer of 1,3-propanediol, 2,5-furandicarboxylic acid and isosorbide; copolymer of 1,3-propanediol, 2,5-furandicarboxylic acid and isomannide.

Suitable furan-based polyester of the barrier layer can include, but is not limited to poly(trimethylene-2,5-furandicarboxylate) (PTF), poly(butylene-2,5-furandicarboxylate) (PBF), or poly(ethylene-2,5-furandicarboxylate) (PEF).

The barrier layer, 110, 210, 310, as shown in FIGS. 1, 2 and 3 can comprise poly(trimethylene furandicarboxylate) (PTF) derived from polycondensation of 1,3-propanediol and any suitable isomer of furan dicarboxylic acid or derivative thereof such as, 2,5-furan dicarboxylic acid, 2,4-furan dicarboxylic acid, 3,4-furan dicarboxylic acid, 2,3-furan dicarboxylic acid or their derivatives. PTF as shown below is derived from polymerization of 2,5-furan dicarboxylic acid or a derivative of the acid form and 1,3-propanediol:

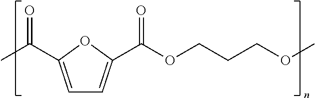

where n=10-1000 or 50-500 or 25-185 or 80-185.

The poly(trimethylene furandicarboxylate) (PTF) as disclosed herein can have a number average molecular weight in the range of 1960-196000 or 1960-98000 or 4900-36260. Also, the PTF can have a degree of polymerization of 10-1000 or 50-500 or 25-185 or 80-185.

The barrier layer, 110, 210, 310, as shown in FIGS. 1, 2 and 3, can comprise a furan-based polyester, which is a copolyester derived from 2,5-furan dicarboxylic acid or a functional equivalent thereof, at least one of a diol or a polyol monomer, and at least one polyalkylene ether glycol (PAEG), wherein the molar ratio of diol or a polyol to polyalkylene ether glycol is at least 2:0.0008. The molar amount of furan dicarboxylic acid, 1,3 propanediol and the at least one polyalkylene ether glycol (PAEG) can be in any suitable range, for example in the range of 1:2:0.0008 to 1:2:0.145 respectively.

The barrier layer, 110, 210, 310, as shown in FIGS. 1, 2 and 3, can further comprise PTF, such that the furan-based polyester is different from PTF and wherein the furan-based polyester and PTF forms a polymer blend comprising 0.1-99.9% or 5-75% or 10-50% by weight of PTF, based on the total weight of the polymer blend composition comprising the furan-based polyester and PTF.

The barrier layer, 110, 210, 310, as shown in FIGS. 1, 2 and 3, can further comprise poly(alkylene terephthalate) (PAT), wherein the furan-based polyester and PAT forms a polymer blend comprising 0.1-99.9% or 5-75% or 10-50% by weight of PAT, based on the total weight of the polymer blend composition comprising the furan-based polyester and PAT. The poly(alkylene terephthalate) include units derived from terephthalic acid and a C₂-C₁₂ aliphatic diol.

The barrier layer of the multilayer structure can have thickness in the range of 0.5-50% or 1-25% or 1-10% or 1-5% of the total thickness of the multilayer structure to provide a permeation barrier to a hydrocarbon fuel, where the total thickness of the multilayer structure can be in the range of 10-100000 microns or 100-10000 microns or 500-8500 microns or 10-2000 microns. The thickness of the barrier layer in the multilayer structure is dependent upon several factors, such as intended application of the article comprising the multilayer structure. For example, the thickness of the barrier layer can be 10% of the total thickness for bottles &/or tanks but may be higher, such as 20-50% of the total thickness for hoses and pipes to provide optimum hydrocarbon barrier and mechanical properties. The barrier layer of the multilayer structure can have thickness in the range of 50-5000 microns, or 100-2500 microns, or 100-1000 microns or 100-500 microns

### Structural Layers

The structural layers, for example the first structural layer 111, 211, 311, 221, 321 and the second structural layer 221, 321 as shown in FIGS. 1-3, may comprise any suitable polymer that can maintain its form after molding by extrusion, lamination, or any other means. Suitable polymers for structural layer include, but are not limited to, polyolefin, polyester, and polyamide.

At least one of the first structural layer 111, 211, 311 or the second structural layer 221, 321 can comprise a polyolefin. The polyolefin homo and copolymers are based on α-olefins including but not limited to ethylene, propylene, 1-butene, 1-pentene, 3-methyl-1-butene, 1-hexene or 4-methyl-1-pentene. Suitable polyolefins include, but are not limited to, polypropylene, biaxially oriented polypropylene (BOPP), polyethylene (PE), high density polyethylene (HDPE), low density polyethylene (LDPE), linear low density polyethylene (LLDPE), medium density polyethylene (MDPE), ultra high molecular weight polyethylene (UHMWPE), crosslinked polyethylene (PEX), very low density polyethylene (VLDPE), polyisobutylene (PIB), polymethylpentene (PMP), polybutene, polyolefin elastomers (POE), ethylene-propylene rubber (EPR), and blend combinations of two or more thereof.

At least one of the first structural layer 111, 211, 311 or the second structural layer 221, 321 can comprise a polyester. Suitable polyesters include, but are not limited to, polyethyleneterephthalate (PET), polybutyleneterephthalate (PBT), polytrimethyleneterephthalate (PTT), polyethylene-2,5-furandicarboxylate (PEF), polybutylene-2,5-furandicarboxylate (PBF), polyethylene-2,6-naphthalate (PEN), PET copolymers utilizing isophthalic acid, cyclohexyldimethanol, or 2,2,4,4-tetramethyl-1,3-cyclobutanediol as comonomers, and blend combinations of two or more thereof.

At least one of the first layer 111, 211, 311 or the second structural layer 221, 321 can comprise a polyamide including, but not limited to an aliphatic polyamide, an aromatic polyamide (polyaramid), a polyamide-imide or mixtures thereof. Suitable polyamides include, but are not limited to, polycapramide (nylon 6), polyundecanamide (nylon 11), polydodecanamide (nylon 12), polyethyleneadipamide (nylon 26), polytetramethyleneadipamide (nylon 46), polyhexamethyleneadipamide (nylon 66), polyhexamethyleneazepamide (nylon 69), polyhexamethylenesebacamide (nylon 610), polyhexamethyleneundecamide (nylon 611), polyhexamethylenedodecamide (nylon 612), polyhexamethylenehexadecamide (nylon 616), polyhexamethyleneoctadecamide (nylon 618), nylon 6/66 copolymer, nylon 6/12/66 terpolymer, polyhexamethyleneterephthalamide (nylon 6T), polyhexamethyleneisophthalamide (nylon 61), polynonamethylenedodecamide (nylon 912), polydecamethylenedecamide (nylon 1010), polydecamethylenedodecamide (nylon 1012), polydodecamethylenedodecamide (nylon 1212), poly(para-phenylene terephthalamide), poly(meta-phenylene terephthalamide), polymetaxyleneadipamide (nylon MXD6), polytrimethylhexamethyleneterephthalamide (nylon TMHT), polybis(4-aminocyclohexyl)methanedodecamide (nylon PACM12), polybis(3-methyl-4-aminocyclohexyly)methanedtdecamide (nylon dimethyl PACM12), polydecamethyleneterephthalamide (nylon 10T), polyundecamethyleneterephthalamide (nylon 11T), polydodecamethyleneterephthalamide (nylon 12T), copolymers and terpolymers (such as nylon 6/66/12) thereof.

The first structural layer 111, 211, 311 and the second structural layer 221, 321 can have the same composition or can have different composition.

The thickness of the first structural layer 111, 211, 311 and the second structural layer 221, 321 can be same or different. Thickness of the structural layer can be in the range of 100-100000 microns, or 100-10000 microns, or 100-6000 microns.

### Tie Layer

The tie layer 112, 212, 312, 322, as shown in FIGS. 1, 2 and 3, comprises one or more olefin copolymers. The tie layers 112, 212, 312, 322 is interposed between the barrier layer and at least one additional layer either the first structural layer or the second structural layer. The first tie layer 312 and the second tie layer 322 can have the same composition or can have the different composition. The one or more olefin copolymers include, but are not limited to, propylene copolymers, ethylene copolymers and mixtures thereof.

“Propylene copolymer” refers to a polymer comprising repeat units derived from propylene and at least one additional monomer. Suitable propylene based copolymers include, but are not limited to, copolymers of propylene with another α-olefin as a monomer, including but not limited to ethylene, 1-butene, 1-pentene, 3-methyl-1-butene, 1-hexene or 4-methyl-1-pentene. Other comonomers include but not limited to maleic anhydride, acrylic acid, acrylates and methacrylates. Copolymers could be either random or block copolymers.

“Ethylene copolymer” refers to a polymer comprising repeat units derived from ethylene and at least one additional monomer.

The one or more ethylene copolymers comprised in the tie layer of the multilayer structure may be chosen among ethylene α-olefin, ethylene vinyl acetate copolymers, ethylene maleic anhydride copolymers, ethylene acrylic acid (or the neutralized salt form of the acid) copolymers, ethylene methacrylic acid (or the neutralized salt form of the acid) copolymers, ethylene glycidyl (meth)acrylate copolymers, ethylene alkyl (meth)acrylate copolymers, or combinations of two or more thereof. “Alkyl (meth)acrylate” refers to alkyl acrylate and/or alkyl methacrylate. Ethylene alkyl (meth)acrylate copolymers are thermoplastic ethylene copolymers derived from the copolymerization of ethylene comonomer and at least one alkyl (meth)acrylate comonomer, wherein the alkyl group contains from one to ten carbon atoms and preferably from one to four carbon atoms. More preferably, the ethylene copolymer comprised in the tie layer are chosen among ethylene .alpha.-olefin, ethylene vinyl acetate copolymers, ethylene methyl (meth)acrylate copolymers, ethylene ethyl (meth)acrylate copolymers, ethylene butyl (meth)acrylate copolymers, or combinations of two or more thereof.

When the ethylene copolymer used in the tie layer is an ethylene α-olefin copolymer, it comprises ethylene and an α-olefin of three to twenty carbon atoms. Preferred α-olefin includes four to eight carbon atoms.

Typically, the density of the ethylene α-olefin copolymers ranges from 0.860 g/cc to 0.925 g/cc, preferably from 0.860 g/cc to 0.910 g/cc and more preferably between 0.880 g/cc to 0.905 g/cc. Resins made by Ziegler-Natta type catalysis and by metallocene or single site catalysis are included provided they fall within the density ranges so described. The metallocene or single site resins useful herein are (i) those which have an I-10/I-2 ratio of less than 5.63 and an Mw/Mn (polydispersivity) of greater than (I-10/I-2)−4.63, and (ii) those based which have an I-10/I-2 ratio of equal to or greater than 5.63 and a polydispersivity equal to or less than (I-10/I-2)−4.63. Preferably the metallocene resins of group (ii) will have a polydispersivity of greater than 1.5 but less than or equal to (I-10/I-2)−4.63. Suitable conditions and catalysts which can produce substantially linear metallocene resins are described in U.S. Pat. No. 5,278,272. The reference gives full descriptions of the measurement of the well-known rheological parameters I-10 and I-2, which are flow values under different load and hence shear conditions. It also provides details of measurements of the well-known Mw/Mn ratio determination, as determined by gel-permeation chromatography (GPC).

When the ethylene copolymer used in the tie layer is an ethylene vinyl acetate copolymer, the relative amount of copolymerized vinyl acetate units is from 2 to 40 wt %, preferably from 10 to 40 wt %, the weight percentage being based on the total weight of the ethylene copolymer. A mixture of two or more different ethylene vinyl acetate copolymers can be used as components of the tie layer in place of a single copolymer.

When the ethylene copolymer is an alkyl (meth)acrylates, the relative amount of copolymerized alkyl (meth)acrylate units is from 0.1 to 45 wt %, preferably from 5 to 35 wt % and still more preferably from 8 to 28 wt %, the weight percentage being based on the total weight of the ethylene copolymer.

The one or more olefin homopolymers and/or copolymers can be modified copolymer, meaning that the copolymer is grafted and/or copolymerized with organic functionalities. Modified polymers for use in the tie layer may be modified with acid, anhydride and/or epoxide functionalities. Examples of the acids and anhydrides used to modify polymers, which may be mono-, di- or polycarboxylic acids are acrylic acid, methacrylic acid, maleic acid, maleic acid monoethylester, fumaric acid, furnaric acid, itaconic acid, crotonic acid, 2,6-naphthalene dicarboxylic acid, itaconic anhydride, maleic anhydride and substituted maleic anhydride, e.g. dimethyl maleic anhydride or citrotonic anhydride, nadic anhydride, nadic methyl anhydride, and tetrahydrophthalic anhydride, or combinations of two or more thereof, maleic anhydride being preferred.

When acid-modified polymer is used, it may contain from 0.05 to 19 wt % of an acid, the weight % being based on the total weight of the modified polymer.

When anhydride-modified polymer is used, it may contain from 0.03 to 2 wt %, preferably from 0.05 to 2 wt % of an anhydride, the weight percentage being based on the total weight of the modified ethylene polymer.

Examples of epoxides used to modify polymers are unsaturated epoxides comprising from four to eleven carbon atoms, such as glycidyl (meth)acrylate, allyl glycidyl ether, vinyl glycidyl ether and glycidyl itaconate, glycidyl (meth)acrylates being particularly preferred. Epoxide-modified ethylene copolymers preferably contain from 0.05 to 15 wt % of an epoxide, the weight percentage being based on the total weight of the modified ethylene copolymer. Preferably, epoxides used to modify ethylene copolymers are glycidyl (meth)acrylates. The ethylene/glycidyl (meth)acrylate copolymer may further contain copolymerized units of an alkyl (meth)acrylate having from one to six carbon atoms and an .alpha.-olefin having 1-8 carbon atoms. Representative alkyl (meth)acrylates include methyl (meth)acrylate, ethyl (meth)acrylate, propyl (meth)acrylate, butyl (meth)acrylate, isobutyl (meth)acrylate, hexyl (meth)acrylate, or combinations of two or more thereof. Of note are ethyl acrylate and butyl acrylate. The α-olefin can be selected from the group of propylene, octene, butene and hexane, especially propylene.

Preferably, modified ethylene copolymers comprised in the tie layer are modified with acid, anhydride and/or glycidyl (meth)acrylate functionalities.

Exemplary ethylene based copolymers include, but are not limited to, polyethylene-co vinylacetate, polyethylene-co-methylacrylate, polyethylene-co-maleic anhydride, polyethylene-co-acrylate (i.e. methylacrylate, ethylacrylate, butylacrylate etc), polyethylene-co-glycidylacrylate, polyethylene-co-glycidylmethacrylate, polyethylene-co-vinylalcohol, polyethylene-co-acrylic acid; polyethylene-co-acrylic acid sodium salt, polyethylene-co-methylmethacrylate, polyethylene-co-methacrylic acid, and polyethylene-co-methacrylic acid sodium salt.

Copolymers and modified polymers useful for the present invention are commercially available for example under the trademarks Elvax®, Elvaloy®, Bynel® from E. I. du Pont de Nemours and Company, (Wilmington, Del.).

The tie layers could also be used to improve the adhesion between layers comprising polar materials, for example polyesters and polyamides. Examples of such tie layers include but are not limited to, polyacrylates, aromatic polyesters, aliphatic polyesters, aliphatic-aromatic copolyesters, polyamides, polyesteram ides, polyvinyl alcohol, aliphatic polycarbonates, aromatic polycarbonates, polymaleic anhydride or grafted polymaleic anhydride, polyvinylacetate, polyvinylacetate-co-maleic anhydride, polyvinylalcohol-co-vinylacetate, polyacrylate-co-vinylacatete, polyacrylate-covinylalcohol, polyacrylate-co-maleic anhydride, polyvinylalcohol-co-maleic anhydride, polyacrylic acid or the neutralized salt form of the acid, polyacrylic acid-co-vinyl alcohol, polyacrylic acid-co-vinyl acetate, polyacrylic acid-co-maleic anhydride, or blends of two or more components.

The thickness of the first tie layer 112, 212, 312 and the second tie layer 222, 322 can be same or different. Thickness of the tie layer can be in the range of 1-1000 microns or 1-500 microns or 1-100 microns or 1-25 microns or 1-10 microns or 1-5 microns or less than 1 micron.

### Additives

One or more layers of the multilayer structure 100, 200, 300, i.e. one or more of the barrier layer 110, 210, 310; structural layer(s) 111, 211, 221, 311, 321; and the tie layer(s) 112, 212, 312, 322 described hereinabove may contain one or more additives including, but not limited to, antioxidants, plasticizers, heat stabilizers, UV light absorbers, antistatic agents, lubricants, colorants, fillers and heat stabilizers. The amount of additives present in each of the barrier layer, structural layer and the tie layer can be in the range of 1 ppm to 5% or 1 ppm to 3% or 1 ppm to 1%.

Suitable antioxidants include, but are not limited to, 2,5-di-tert-butylhydroquinone, 2,6-di-tert-butyl-p-cresol, 4,4′-thiobis-(6-tert-butylphenol), 2,2′-methylene-bis-(4-methyl-6-tert-butylphenol), octadecyl-3-(3′,5′-di-tert-butyl-4′-hydroxyphenyl) propionate, 4,4′-thiobis-(6-tert-butylphenol), etc.

Suitable UV light absorbers include, but are not limited to, ethylene-2-cyano-3,3′-diphenyl acrylate, 2-(2′-hydroxy-5′-methylphenyl)benzotriazole, 2-(2′-hydroxy-5′-methylphenyl)benzotriazole, 2-(2′-hydroxy-3′-tert-butyl-5′-methylphenyl)-5-chlorobenzotriazole, 2-hydroxy-4-methoxybenzophenone, 2,2′-dihydroxy-4-methoxybenzophenone, 2-hydroxy-4-methoxybenzophenone, etc.

Suitable plasticizers include, but are not limited to, phthalic acid esters such as dimethyl phthalate, diethyl phthalate, dioctyl phthalate, waxes, liquid paraffins, phosphoric acid esters, etc.

Suitable antistatic agents include, but are not limited to, pentaerythritol monostearate, sorbitan monopalmitate, sulfated polyolefins, polyethylene oxide, carbon wax, etc.

Suitable lubricants include, but are not limited to, ethylene bisstearoamide, butyl stearate, etc.

Suitable colorants include, but are not limited to, carbon black, phthalocyanine, quinacridon, indoline, azo pigments, red oxide, etc.

Suitable filler include, but are not limited to, glass fiber, asbestos, ballastonite, calcium silicate, talc, montmorillonite, etc.

Articles

In an aspect, the multilayer structure, as disclosed herein above is in a form of a housing provided with a port for introducing a hydrocarbon fuel in an enclosure defined by the housing, wherein the multilayer structure provides permeation barrier to the hydrocarbon fuel.

The housing can be in a form of a hose, a pipe, a duct, a tube, a tubing or a conduit.

The housing can be in a form of a fuel container, a fuel container with a lid, a fuel container with a closure, a fuel canister, a fuel valve, a fuel inlet, a fuel filler neck, a fuel tank or a fuel line.

Suitable hydrocarbon fuels include, but are not limited to, ethanol, methanol, butanol, toluene, xylene, isooctane, gasoline, kerosene, liquefied petroleum, diesel, biodiesel, and mixtures thereof.

In another aspect, there is an article for storage or transport of a hydrocarbon fuel comprising the multilayer structure as disclosed hereinabove, in a form of a housing provided with a port for introducing hydrocarbon fuel in an enclosure defined by the housing, wherein the multilayer structure provides permeation barrier to the hydrocarbon fuel. The article may further comprise means for closing the port, such that upon closing the port, the material is isolated from the outside environment. The article can be in a form selected from the group consisting of a fuel container, a fuel container with a lid, or a fuel container with a closure, a fuel canister, a fuel valve, a fuel inlet, a fuel filler neck, a fuel tank or a fuel line.

In an embodiment, the article is in a form of a gas tank and comprises a multilayer structure with HDPE as a structural layer, furan-based polyester of the present disclosure as a barrier layer, and an ethylene copolymer as a tie layer, thereby forming one or more of the following layered structures:
HDPE/Ethylene copolymer/furan-based polyester
HDPE/Ethylene copolymer/PTF
HDPE/Ethylene copolymer/furan-based polyester/Ethylene copolymer/HDPE
HDPE/Ethylene copolymer/PTF/Ethylene copolymer/HDPE

The article in the form of a gas tank comprising the furan-based polyester as a barrier layer, can be mounted on automobiles, motor cycles, ships, airplanes, electric generators, lawn tractors snow-mobiles; small portable equipment, for example string trimmer, blowers (leaf & snow), pressure washers, mowers, generators; other household, industrial and agricultural machines. The article can be in the form of portable containers such as jerry can. The article can also be in the form of containers for storing fuels.

In another embodiment, the article is in a form of a fuel line and comprises a multilayer structure with Nylon as a structural layer and PTF as a barrier layer, with or without a tie layer, thereby forming one or more of the following layered structures:
Nylon/tie/furan-based polyester
Nylon/tie/PTF
Nylon/tie/furan-based polyester/tie/Nylon
Nylon/tie/PTF/tie/Nylon

The article in the form of a fuel line comprising the furan-based polyester as a barrier layer, can be mounted on automobiles, motor cycles, ships, airplanes, electric generators, lawn tractors snow-mobiles; small portable equipment, for example string trimmer, blowers (leaf & snow), pressure washers, mowers, generators; other household, industrial and agricultural machines.

The overall thickness of the article for storage or transport of a hydrocarbon fuel, such as fuel container is preferably 10-100000 microns or 100-10000 microns or 500-8500 microns or 1000-7000 microns. It is noted that the thickness is the average thickness of the fuel container measured at the body thereof. If the overall thickness is excessively thick, the weight will become too large, leading to an adverse effect on fuel consumption of automobiles and also to increase in the cost of the fuel container. On the other hand, if the overall thickness is excessively thin, sufficient stiffness may not be maintained, leading to a problem that a fuel container is easily broken. It therefore is important to determine a thickness according to the capacity and intended use of the fuel container.

The method for producing the articles as disclosed herein above and especially, fuel container made of the multilayer structure of the present invention, is not particularly restricted, and examples thereof include molding methods conducted in the field of general polyolefin or polyester or polyamide, such as extrusion molding, blow molding, and injection molding. In particular, co-extrusion molding and co-injection molding are preferred. Among these, co-extrusion blow molding is most preferred.

Disclosed is a method of storing or transporting a hydrocarbon fuel comprising providing a housing with a port for introducing the hydrocarbon fuel in an enclosure defined by the housing, wherein the housing comprises furan-based polyester as a hydrocarbon fuel barrier layer, as disclosed hereinabove.

Disclosed is a method of transporting a hydrocarbon fuel with minimal permeation through a multilayered tube or a hose in which a hydrocarbon fuel is introduced in the multi-layered tube or a hose through an entry port and exited through an exit port, wherein the multilayered tube comprises furan-based polyester as a hydrocarbon fuel barrier layer, as disclosed hereinabove. The hydrocarbon fuel is a hydrocarbon fluid and the multilayered tube is a fuel line.

Disclosed is a method of reducing fuel permeation through a fuel tank comprising providing a fuel tank having furan-based polyester as a hydrocarbon fuel barrier layer, as disclosed hereinabove.

In an embodiment, the fuel line and fuel tank comprises poly(trimethylene furandicarboxylate) as a hydrocarbon fuel barrier layer.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

As used herein, the phrase “one or more” is intended to cover a non-exclusive inclusion. For example, one or more of A, B, and C implies any one of the following: A alone, B alone, C alone, a combination of A and B, a combination of B and C, a combination of A and C, or a combination of A, B, and C.

Also, use of “a” or “an” are employed to describe elements and described herein. This is done merely for convenience and to give a general sense of the scope of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the disclosed compositions, suitable methods and materials are described below. In addition, the materials, methods, and examples are illustrative only and not intended to be limiting.

In the foregoing specification, the concepts have been disclosed with reference to specific embodiments. However, one of ordinary skill in the art appreciates that various modifications and changes can be made without departing from the scope of the invention as set forth in the claims below.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all embodiments.

It is to be appreciated that certain features are, for clarity, described herein in the context of separate embodiments, may also be provided in combination in a single embodiment. Conversely, various features that are, for brevity, described in the context of a single embodiment, may also be provided separately or in any sub combination. Further, reference to values stated in ranges include each and every value within that range.

The concepts disclosed herein will be further described in the following examples, which do not limit the scope of the invention described in the claims.

The examples cited here relate to hydrocarbon fuel permeation barrier layer comprising furan-based polyesters. The discussion below describes how furan-based polyesters, and multilayer structures comprising furan-based polyesters can be formed for use as a hydrocarbon fuel barrier layer.

### EXAMPLES

### Test Methods

### Molecular Weight by Size Exclusion Chromatography

A size exclusion chromatography system, Alliance 2695™ (Waters Corporation, Milford, Mass.), was provided with a Waters 414™ differential refractive index detector, a multi-angle light scattering photometer DAWN Heleos II (Wyatt Technologies, Santa Barbara, Calif.), and a ViscoStar™ differential capillary viscometer detector (Wyatt). The software for data acquisition and reduction was Astra® version 5.4 by Wyatt. The columns used were two Shodex GPC HFIP-806M™ styrene-divinyl benzene columns with an exclusion limit of 2×10⁷ and 8,000/30 cm theoretical plates; and one Shodex GPC HFIP-804M™ styrene-divinyl benzene column with an exclusion limit 2×10⁵ and 10,000/30 cm theoretical plates.

The specimen was dissolved in 1,1,1,3,3,3-hexafluoro-2-propanol (HFIP) containing 0.01 M sodium trifluoroacetate by mixing at 50° C. with moderate agitation for four hours followed by filtration through a 0.45 μm PTFE filter. Concentration of the solution was circa 2 mg/m L.

Data was taken with the chromatograph set at 35° C., with a flow rate of 0.5 ml/min. The injection volume was 100 μl. The run time was 80 min. Data reduction was performed incorporating data from all three detectors described above. Eight scattering angles were employed with the light scattering detector. No standard for column calibration was involved in the data processing.

### Molecular Weight by Intrinsic Viscosity

Intrinsic viscosity (IV) was determined using the Goodyear R-103B Equivalent IV method, using T-3, Selar® X250, Sorona®64 as calibration standards on a Viscotek® Forced Flow Viscometer Modey Y-501C. Methylene chloride/trifluoro acetic acid was the solvent carrier.

### Thermal Analysis

Glass transition temperature (T_{g}) and melting point (Tₘ) were determined by differential scanning calorimetry (DSC) performed according to ASTM D3418-08.

### ¹H-NMR Spectroscopy

¹H-NMR spectra were recorded on a 400 MHz NMR in either deuterated hexafluoroisopropanol (HFIP-d) or tetrachloroethane (tce-d2). Proton chemical shifts are reported in ppm downfield of TMS using the resonance of the deuterated solvent as internal standard.

### Gas Barrier Testing

Permeation to hydrocarbon fuel mixtures was tested according to standard test SAE International™ surface vehicle standard J2659 at a testing temperature of 40° C. Produced samples were tested to either CM15 which is a mix of methanol (15%), toluene (42.5%) and iso-octane (42.5%), or CE10 which is a mix of ethanol (10%), toluene (45%) and iso-octane (45%). CM15 is considered a more aggressive fuel mixtures due to the smaller molecular size of methanol (MeOH) vs. ethanol (EtOH). Results are depicted as g-mm/m²-day. The total thickness of the multi-layer (three-layer and five-layer) structure was used to calculate the permeability rates of the multi-layer structures.

### Adhesion Testing

Adhesion between different layers of the multi-layer structures was evaluated according to ASTM F904 with test samples cut according to ASTM D882.

### Materials

As used in the Examples below, 1,3-propanediol (bioPDO™), and 10 mils thick Kapton® polyimide film, were obtained from the DuPont Company (Wilmington, Del.) and were used as received, unless otherwise noted. PET AA72 poly(ethylene terephthalate) 0.82 IV (contains 1.9 mol % isophthalic acid) was obtained from NanYa and used as received. Titanium(IV)isopropoxide, ethylene glycol, and 1,4-butanediol were obtained from Aldrich and used as received. 2,5-furandimethylester (FDME) was obtained from Sarchem labs (Farmingdale, N.J.) and used as received.

EVOH, Eval® F171B (32 mole % ethylene) and Eval® J102 (32 mole % ethylene) were obtained from Kuraray America (Houston, Tex.) and was used as-received.

Two commercially available high density polyethylene (HDPE) were used as received as structural layer. Paxon46-055 (Melt Flow Index (190° C./2.16 kg) <0.10 g/10 min) was obtained from ExxonMobil and was used for multi-layer laminates and is referred as HDPE-P-E. A lower viscosity, HDPE, Sclair 2907 (Melt Flow Index (190° C./2.16 kg) ˜4.9 g/10 min) was obtained from Nova Chemicals and was used for coextrusion and is referred as HDPE-S-N. An extrusion grade of homopolymer polypropylene (PP), PAG3Z-050 (Melt Flow Index (190 C/2.16 kg) ˜3.5 g/10/min) was obtained from Flint Hills.

Commercially available tie layers: Bynel® 21E533 (anhydride modified ethylene acrylate), Bynel® E418 (anhydride modified ethylene vinyl acetate), Bynel® 22E999 (modified ethylene acrylate), Bynel 50E662 (anhydride modified homopolypropylene), Elvaloy® AS (ethylene/nbutyl acrylate/glycidyl methacrylate terpolymer), Fusabond® N525 and Bynel® 41E754 (anhydride modified ethylene copolymers) were received from DuPont Company (Wilmington, Del.) and were used as received.

### Comparative Example A

### Preparation of a Compression Molded PET Film

A PET AA72 was compression molded into 0.1-0.12 millimeter thick films using a hydraulic platen press. The polymer pellets were placed in a 15×15 centimeter frame supported on Kapton® film. The polymer sample and the Kapton® film was placed between two sheets of fiberglass reinforced Teflon® and in turn between two brass sheets and placed into a pre-heated Pasadena press. The press was pre-heated to the desired temperature (210° C. for PBF, 230° C. for PTF, 250° C. for PEF, and 260° C. for CE-PET) and the film sandwich was placed between the platen. The platen was subjected to 20,000 psig pressure for a period of 5-8 minutes. The film sandwich was removed and placed between two cooling plates for quenching purposes. The produced and quenched film was separated from the Teflon® sheet, and measured for its permeation. DSC confirmed that films so produced were fully amorphous and no melting was observed, i.e. enthalpy of melting <<1 J/g.

The compression molded PET film was analyzed for permeation towards CM15 hydrocarbon fuel mixture, and the results are summarized in Table 1.

### Example 1

### Compression Molded Poly(trimethylene-2,5-furandicarboxylate) (PTF) Film for Use as a Hydrocarbon Fuel Barrier Layer

Step 1A: Synthesis of High Molecular Weight poly(trimethylene-2,5-furandicarboxylate) (PTF)

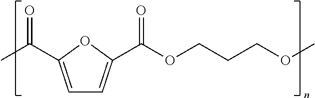

2,5-furandimethylester (147.3 g, 0.8 mol), and bioPDO™ (109.5 g, 1.44 mol) were charged to a pre-dried 500 mL three necked kettle reactor fitted with an overhead stirrer and a distillation condenser. A nitrogen purge was applied to the flask which was kept at a temperature of 23° C. Stirring was commenced at 50 rpm to form a slurry. While stirring, the flask was evacuated to 0.13 MPa and then repressurized with N₂, for a total of 3 cycles. After the first evacuation and repressurization, titanium (IV) isopropoxide (93 mg) was added.

After the 3 cycles of evacuation and repressurization, the flask was immersed into a preheated liquid metal bath set at 160° C. The contents of the flask were stirred for 20 min after placing it in the liquid metal bath, causing the solid ingredients to melt. Next, the stirring speed was increased to 180 rpm and the liquid metal bath setpoint was increased to 160° C. After about 20 minutes, the bath had come up to temperature, after which the metal bath setpoint was increased to 180° C. After about 20 min, the bath had come to temperature. The flask was then held at 180° C. still stirring at 180 rpm for an additional 45-60 minutes to distill off most of the methanol being formed in the reaction. Following the hold period at 180° C., the metal bath setpoint was increased to 210° C. After about 20 minutes, the bath had come to temperature. The flask was then held at 210° C. still stirring at 180 rpm for an additional 45-60 min after which the nitrogen purge was discontinued, an additional charge of titanium (IV) isopropoxide (93 mg) added, and a vacuum was gradually applied in increments of approximately 1330 Pa every 10 s while stirring continued. After about 60 min the vacuum leveled out at 6500-8000 Pa. The stirring speed was then kept between 50-180 rpm and the metal bath set point increased to 250° C. After about 20 min, the bath had come to temperature and the conditions were maintained for ˜3 hours. Periodically, the stirring speed was increased to 180 rpm, and then the stirrer was stopped. The stirrer was restarted, and the applied torque about 5 seconds after startup was measured. When a torque of 75 N/cm or greater was observed, reaction was discontinued by halting stirring and removing the flask from the liquid metal bath. The overhead stirrer was elevated from the floor of the reaction vessel, the kettle removed, and the produced polymer recovered by decanting under a stream of nitrogen gas. The recovered polymer was chopped into pellets using a Wiley mill that was cooled with liquid nitrogen. The so produced polymer pellets were dried under vacuum and a weak nitrogen stream at 115° C. for 24 hours. The yield was ˜120 g. T_{g} was ca. 58° C. (DSC, 5° C./min, 2^{nd} heat), Tₘ was ca. 176° C. (DSC, 5° C./min, 2^{nd} heat). ¹H-NMR (TCE-d) δ: 7.05 (s, 2H), 4.40 (m, 4H), 2.15 (m, 2H). Mₙ (SEC) ˜15 200 D, PDI 1.85. IV ˜0.75 dL/g.

### Step 1B: PTF Film Preparation by Compression Molding

A procedure similar to that described in Comparative Example A was used to prepare a compression molded film from the PTF polymer prepared in step 1A, except that the press was pre-heated to 230° C. for PTF instead of 260° C. as for PET.

The compression molded PTF film was analyzed for permeation towards CM15 and CE10 hydrocarbon fuel mixtures, and the results are summarized in Table 1 and Table 2 respectively.

### Example 2

### Compression Molded Poly(buylene-Z5-furandicarboxylate) (PBF) Film for Use as a Hydrocarbon Fuel Barrier Layer

Step 2A: Synthesis of a Polyester, PBF from 2,5-furandimethylester, and 1,4-butanediol

1,4-butanediol (146.8 g, 1.63 mol) and FDME (150 g, 0.81 mol) were polymerized using Tyzor®TPT as catalyst (210 μL) using the same setup as used in step 1A of Example 1 above except the monomer were different. The only difference was that the final condensation set temperature was 240° C. The recovered polymer yield was ˜120 g. Tg was ˜39° C., Tm was ˜169° C. (second heating, 10° C.). 1H-NMR (tce-d) δ: 7.30 (m, 2H), 4.70-4.30 (m, 4H), 2.0 (m, 4H). Mn (SEC) ˜16 800 D, PDI 3.56 (SEC). IV ˜1.12 dL/g.

### Step 2B: PBF Film Preparation by Compression Molding

A procedure similar to that described in Comparative Example A was used to prepare a compression molded film from the PBF polymer prepared in step 2A, except that the press was pre-heated to the desired temperature of 210° C. for PBF instead of 260° C. as for PET.

The compression molded PBF film was analyzed for permeation towards CM15 and CE10 hydrocarbon fuel mixtures, and the results are summarized in Table 1 and Table 2 respectively.

### Example 3

### Compression Molded Poly(ethylene-Z5-furandicarboxylate) (PEF) Film for Use as a Hydrocarbon Fuel Barrier Layer

Step 3A: Synthesis of a Polyester, PEF from 2,5-furandimethylester, and Ethylene Glycol (PEF)

Ethylene glycol (101.2 g, 1.63 mol) and FDME (150 g, 0.81 mol) were polymerized using Tyzor®TPT as catalyst (180 μL) using the same setup as used in Example 1 above except the monomer were different. The only difference was that the ester interchange was made at 180° C. for 60 minutes and 200° C. for 60 minutes. The recovered polymer yield was ˜63 g. Tg was 89° C., Tm was ˜214° C. (second heating, 10° C.). 1H-NMR (HFIP-d) δ: 7.30 (m, 2H), 4.70-4.30 (m, 4H). Mn (SEC) ˜16 700 D, PDI (SEC) 2.0. IV ˜0.59 dL/g.

The thus obtained chopped pellets were polymerized in the solid state to increase the molecular weight. Under vacuum the pellets were heated at 200° C. for 72 hours, the obtained and final IV was ˜0.96 dL/g.

### Step 3B: PEF Film Preparation by Compression Molding

A procedure similar to that described in Comparative Example A was used to prepare a compression molded film from the PTF polymer prepared in step 1A, except that the press was pre-heated to the desired temperature of 250° C. for PEF instead of 260° C. as for PET

The compression molded PEF film was analyzed for permeation towards CM15 hydrocarbon fuel mixture, and the results are summarized in Table 1.

### Example 4

### Extruded Poly(trimethylene-2,5-furandicarboxylate) (PTF) Film for Use as a Hydrocarbon Fuel Barrier Layer

Step 4A: Preparation of a PTF Pre-Polymer by Polycondensation of bioPDO™ and FDME

2,5-furandimethylester (2557 g), 1,3-propanediol (1902 g), titanium (IV) isopropoxide (2 g), Dovernox-10 (5.4 g) were charged to a 10-lb stainless steel stirred autoclave (Delaware valley steel 1955, vessel #: XS 1963) equipped with a stirring rod and condenser. A nitrogen purge was applied and stirring was commenced at 30 rpm to form a slurry. While stirring, the autoclave was subject to three cycles of pressurization to 50 psi of nitrogen followed by evacuation. A weak nitrogen purge (˜0.5 L/min) was then established to maintain an inert atmosphere. While the autoclave was heated to the set point of 240° C. methanol evolution began at a batch temperature of 185° C. Methanol distillation continued for 120 minutes during which the batch temperature increased from 185° C. to 238° C. When the temperature leveled out at 238° C., a second charge of titanium (IV) isopropoxide (2 g) was added. At this time a vacuum ramp was initiated that during 60 minutes reduced the pressure from 760 torr to 300 torr (pumping through the column) and from 300 torr to 0.05 torr (pumping through the trap). The mixture, when at 0.05 torr, was left under vacuum and stirring for 5 hours after which nitrogen was used to pressurize the vessel back to 760 torr.

The formed polymer was recovered by pushing the melt through an exit valve at the bottom of the vessel and into a water quench bath. The thus formed strand was strung through a pelletizer, equipped with an air jet to dry the polymer free from moisture, cutting the polymer strand into chips ˜¼ inch long and ˜⅛ inch in diameter. Yield was approximately 2724 g (˜5 lbs). T_{g} was ca. 58° C. (DSC, 5° C./min, 2^{nd} heat), Tₘ was ca. 176° C. (DSC, 5° C./min, 2^{nd} heat). ¹H-NMR (TCE-d) δ: 7.05 (s, 2H), 4.40 (m, 4H), 2.15 (m, 2H). Mₙ (SEC) ˜10 300 D, PDI 1.97. IV ˜0.55 dL/g.

### Step 4B: Preparation of High Molecular Weight PTF Polymer by Solid Phase Polymerization of the PTF Pre-Polymer of Step 4A

In order to increase the molecular weight of the PTF pre-polymer (described above) solid phase polymerization was conducted using a heated fluidized nitrogen bed. The quenched and pelletized PTF pre-polymer was initially crystallized by placing the material in an oven, subsequently heating the pellets under a nitrogen purge to 120° C. for 240 minutes. At this time the oven temperature was increased to ˜168° C. and the pellets left under nitrogen purge condition to build molecular weight during a total duration of 96 hours. The oven was turned off and the pellets allowed to cool. The obtained pellets had a measured IV ˜0.99 dL/g.

Step 4C: Preparation of a PTF Film through Extrusion

For film extrusion a 30 mm W&P (Werner & Phleiderer) twin screw extruder was used equipped with a 60/200 mesh filter screen and a 25 centimeter wide film casting die. PTF pellets were fed and the extruder barrel sections (11 in total) and die were all set at 230° C., the extruder feed temperature was set at 180° C. A vacuum port was used on barrel section 6. The feed rate was 10 pounds per hour and the extruder screw speed was 125 rpm. The panel melt temperature was measured at 233° C. The film was collected after being cast on a cooling drum with a temperature set point of 40° C., the measured film thickness was ˜0.1 millimeter and the width was about 22 centimeter. Following the casting process the produced film was cut into paper sized films (˜20×30 centimeter) and used for further testing.

The extruded PTF film was analyzed for permeation towards CE10 hydrocarbon fuel mixture, and the results are summarized in Table 2.

### Example 5

### Extruded Crystallized PTF Film for Use as a Hydrocarbon Fuel Barrier Layer

Step 5A: Preparation of PTF Pre-Polymer by Polycondensation of bioPDO™ and FDME

2,5-furandimethylester (27000 g), 1,3-propanediol (20094 g), titanium (IV) butoxide (40.8 g), were charged to a 100-lb stainless steel stirred reactor equipped with a stirring rod, agitator, and condenser tower. A nitrogen purge was applied and stirring was commenced at 51 rpm to form a slurry. While stirring, the reactor was subject to a weak nitrogen purge to maintain an inert atmosphere. While the autoclave was heated to the set point of 243° C. methanol evolution began at a batch temperature of ˜158° C. Methanol distillation continued for 265 minutes during which the batch temperature increased from 158° C. to 244° C. Following completion of the methanol distillation a vacuum ramp was initiated that during 120 minutes reduced the pressure from 760 torr to 1 torr. The mixture, when at 1 torr, was left under vacuum and stirring for 165 min, reaching a minimum pressure of 0.56 torr in addition to periodic reduction in the stirring rate, after which nitrogen was used to pressurize the vessel back to 760 torr.

The formed polymer was recovered by pumping the melt through an exit valve at the bottom of the vessel and into a water quench bath. The thus formed strands were strung through a pelletizer, equipped with an air jet to dry the polymer free from moisture, cutting the polymer strand into pellets. Yield was approximately 24710 g. IV ˜0.63 dL/g.

### Step 5B: Preparation of High Molecular Weight PTF Polymer by Solid Phase Polymerization of PTF Pre-Polymer

In order to increase the molecular weight of the PTF pre-polymer (described above) solid phase polymerization was conducted using a rotary drum fitted with a heated N₂ purge. The quenched and pelletized PTF pre-polymer was initially crystallized by placing the material in the rotary drier, subsequently heating the pellets under a nitrogen purge to 110° C., held for 240 minutes and cooled. The crystallized pellets were sieved to remove agglomerates and broken pieces. The crystallized pellets were placed back in the rotary drier, the temperature was increased to ˜165° C., and the pellets were left under a heated nitrogen purge condition to build molecular weight during a total duration of 277 h. The oven was turned off and the pellets were allowed to cool. The obtained pellets had a measured IV ˜1.005 dL/g.

### Step 5C: Preparation of a Crystallized PTF Film by Annealing

Film was prepared using PTF from step 5B by extrusion in the same manner as in step 4C of Example 4. This extruded PTF film was crystallized by annealing in a vacuum oven with a Nitrogen sweep at 110° C. overnight. The thickness of this film was 0.012 inches.

The extruded crystallized PTF film was analyzed for permeation towards CM15 hydrocarbon fuel mixture, and the results are summarized in Table 1.

### Comparative Example B

### Extruded EVOH Film for Use as a Hydrocarbon Fuel Barrier Layer

Ethylene vinyl alcohol EVOH films were extruded in the same manner as in step 4C of Example 4. The thickness of this EVOH film was about 0.25 mm.

The extruded EVOH film was analyzed for permeation towards CM15 hydrocarbon fuel mixture, and the results are summarized in Table 1. Some variability is inherent to the measurement, differences in sample thickness and quality also contribute.

TABLE 1
CM15 Permeation rates for Mono-Layer films

| | | | CM15 Composition - % (MeOH/-Iso- | | | |
|---|---|---|---|---|---|---|
| | | | octane/Toluene): 15/42.5/42.5 | | | |
| | | | MeOH | Iso-Octane | Toluene | Total |
| | Monolayer | Thickness | (g-mm/m2- | (g-mm/m2- | (g-mm/m2- | (g-mm/m2- |
| Sample | Composition | (mm) | day) | day) | day) | day) |
| Example 1 | PTF | 0.177 | 0.0106 | 0 | 0.0002 | 0.0108 |
| | | 0.293 | 0.0076 | 0.0011 | 0.0003 | 0.0122 |
| Example 2 | PBF | 0.144 | 3.2182 | 0.0037 | 0.0413 | 3.2632 |
| | | 0.144 | 3.313 | 0.0014 | 0.032 | 3.3464 |
| Example 3 | PEF | 0.00552 | 0.9462 | 0.931 | 1.3307 | 3.2085 |
| | | 0.00536 | 1.9025 | 0.742 | 1.1652 | 3.8092 |
| Example 5 | cPTF | 0.326 | 0.0034 | 0.0003 | 0.0008 | 0.0046 |
| Comparative | PET | 0.215 | 0.8046 | 0.063 | 0.2305 | 1.098 |
| Example A | | | | | | |
| Comparative | EVOH | 0.276 | 9.482 | 0.0006 | 0.28 | 9.5106 |
| Example B | | 0.326 | 8.0614 | 0.0008 | 0.0306 | 8.0929 |

Table 1 shows that furan-based polyesters, polyalkylene furandicarboxylates such as PTF, PBF and PEF all show total better permeation barrier to for CM15 fuel composition as compared to the comparative EVOH, which is the most commonly used polymeric hydrocarbon barrier. Hence, PTF, PBF and PEF are all suitable for use as a hydrocarbon barrier layer in a multi-layer structure comprising structural layer(s) and tie layer(s).

Table 1 also shows that out of the three polyalkylene furandicarboxylates tested, PTF has the best barrier to CM15 fuel and is close to three orders of magnitude better than the EVOH mono-layer tested. Furthermore, the barrier performance of PTF to CM15 fuel can be further improved by crystallization, as shown by crystallized PTF (cPTF) of Example 5 and both PTF (Example 1) and cPTF (Example 5) have better CM15 fuel permeation barrier than PET and EVOH.

TABLE 2
CE10 Permeation rates for Mono-Layer films

| | | | CE10 Composition - % (EtOH/-Iso- | | | |
|---|---|---|---|---|---|---|
| | | | octane/Toluene): 10/45/45 | | | |
| | | | EtOH | Iso-Octane | Toluene | Total |
| | | Thickness | (g-mm/m²- | (g-mm/m²- | (g-mm/m²- | (g-mm/m²- |
| Sample | Composition | (mm) | day) | day) | day) | day) |
| Example 1 | PTF | 0.143 | 0.0062 | 0.0006 | 0.0017 | 0.0086 |
| Example 4 | PTF (SSP) | 0.203 | 0.0068 | 0.0055 | 0.0117 | 0.0240 |
| Example 2 | PBF | 0.132 | 0.0638 | 0.0003 | 0.0068 | 0.0709 |

Table 2 shows that PBF has better permeation barrier towards CE10 as compared to CM15 fuel due to ethanol being a bigger molecule present in CE10 as compared to methanol present in CM15. From these permeation data, PTF shows exceptional performance towards the fuel blend components: methanol, ethanol, iso-octane and toluene.

### Example 6

### Three-Layer Laminated Structure (PTF/Bynel/HDPE) for Use as a Hydrocarbon Fuel Barrier Layer

### Preparation of a Three-Layer Laminate Film in a Hot Press

PTF pellets prepared in step 5B of Example 5 and HDPE-P-E pellets were pressed at 250° C. and 220° C., respectively, into 5-8 mil thick films (15 cm×15 cm) using the above polymer film preparation procedure. A sheet of 2 mil thick Bynel 21E533 film (tie layer) was interposed between a sheet of PTF film and a sheet of HDPE film. The resulting tri-layer structure was placed between two sheets of PFA fluoropolymer release sheets to prevent sticking to the brass sheets and then placed on top of a warm brass sheet to form a three-layer sample. Excess air pockets were removed from the 3-layer sample by pressing the sample with a squeegee and followed by a hand roller. The three-layer sample was then placed on a pre-heated Pasadena press at 240° C. and allowed to heat on the platen for 60 s, and then subjected to 40 psig of pressure for 30 s. The three-layer sample was briefly lowered for a few seconds and then pressed again at 40 psig for 30 s. A total of three press-release cycles were performed in order to minimize air bubbles in the three-layer laminated sample. The three-layer laminated sample was removed from the press and placed between two cooling plates. The cooled three-layer laminated film was separated from the PFA release sheets and measured for its permeation. Thickness of the three-layer structure was 0.017 inches.

The laminated three-layer structure with PTF as the barrier layer and facing the fuel, was analyzed for permeation towards CM15 hydrocarbon fuel mixture, and the results are summarized in Table 3.

### Comparative Example C

### Five-Layer Coextruded Sheet Structure (Polypropylene/Bynel®/EVOH/Bynel®/Polypropylene) for Use as a Hydrocarbon Fuel Barrier Layer

The 5-layer sheet (about 600 mm wide and about 0.72 mm) was produced in a semi-commercial Sano 5-layer coextrusion line. The nominal layer thickness distribution was 45/2.5/5/2.5/45 in terms of % thickness. The actual sample tested has a total thickness of about 0.72 millimeter in which the EVOH layer has a thickness of about 0.025 millimeter. The processing conditions of the 4 extruders were set in accordance with standard processing conditions recommended by the various suppliers of the resins utilized and the die temperature was maintained at 230° C. Speed line varied from 5-8 m/min. Resins utilized included homopolymer PP P4G3Z-050 (3.5 MI), Bynel® 50E662 in the tie layers and EVAL® J102 as the barrier layer.

### Example 7

### Co-extruded Five-layer Structure—A/B/C/B/A (HDPE/Bynel/PTF/Bynel/HDPE) for Use as a Hydrocarbon Fuel Barrier Layer

Step 7A: Processing of Remainder PTF Polymer from Step 1

The process outlined in step 5A of Example 5 used to prepare PTF pre-polymer resulted in ˜3 kg remainder of PTF pre-polymer that is either not converted into pellets or is outside the specification for pellet size. This preparation was repeated nine more times. This remainder includes pellets, uncut strands, and solid polymer collected during the pelletization process and removal of the polymer melt from the reactor. The remainder collected in each of the ten preparations of Step 5A was combined and further upgraded into more usable form of product. The solid portions were frozen with liquid nitrogen and broken into small pieces with a hammer. The total remainder was then cryo-ground in a hammer mill to produce a mixture of powder and polymer particles. The ground remainder was then melt processed using a 30 mm twin-screw extruder (ZSK 30 by Coperion) operating at a barrel temperature of 230° C. and a mass throughput of 30 lb/h. The polymer melt was extruded through a single hole die and into a water quench bath. The thus formed strand was strung through a pelletizer, equipped with an air jet to dry the polymer free from moisture, cutting the polymer strand into pellets. Yield of the processed remainder was approximately 27100 g of pellets. IV ˜0.63 dL/g.

The SEC analysis showed that the polyester had Mₙ (SEC) 13,120 Da and PDI 2.2.

### Step 7B: Preparation of High Molecular Weight PTF Polymer by Solid Phase Polymerization of PTF Pre-Polymer Remainder

In order to increase the molecular weight of the PTF pre-polymer remainder, solid phase polymerization (SPP) was conducted using a convection oven with a N₂ purge. The quenched and pelletized remainder was initially crystallized by placing the material in a convection oven, subsequently heating the pellets under a nitrogen purge to 110° C. for 240 minutes, and then cooling to room temperature. The crystallized pellets were sieved to remove agglomerates and broken pellets. The crystallized and sieved pellets were placed back in the convection oven, the temperature was increased to about 165° C., and the pellets were left under a heated nitrogen purge to build molecular weight during a total duration of 168 h. The oven was turned off and the pellets were allowed to cool to room temperature. The obtained pellets had a measured IV ˜1.06 dL/g.

Step 7C: Preparation of Five-Layer Films through Coextrusion

Five-layer A-B-C-B-A films were prepared by coextrusion. The A layers were prepared from HDPE-S-N. The B layers are commercially available tie layers including Bynel® 21E533, Bynel® E418, Bynel® 22E999, Elvaloy® AS, Fusabond® N525 and Bynel® 41E754. The C layer was the barrier layer, using PTF from Step 7B. Six different multi-layer films were prepared with PTF as a barrier layer including each of the B tie layers listed. The extruder rate was set to achieve a nominal 35%/10%/10%/10%/35% by volume distribution of the layers.

The A layer was fed from a 44 mm (1¾″) diameter single screw extruder with a screw length to screw diameter (L/D) ratio of 24/1. The extruder was built by NRM. The screw speed was 25 RPM and the 1, 2, and 3 barrel zone temperature set points were 190° C., 200° C., and 230° C., respectively. The B layer was fed from a 25 mm (1″) diameter single screw extruder with a 30/1 L/D ratio. The extruder was built by the Davis Standard Company. The screw speed was 31 RPM and the 1, 2, 3, and 4 barrel zone set points were 190° C., 200° C., 210 and 220° C., respectively, except for the five-layer structure with Bynel 41E754 as the tie layer, where the set points were 200° C., 210° C., 220° C., and 230° C. The C layer was fed from a 32 mm (1¼) diameter single screw extruder with a 30/1 L/D ratio. The extruder was built by Wayne Machine and Die. The screw speed was 8 RPM for PTF and the 1, 2, 3, and 4 barrel zone temperature set points were 190° C., 200° C., 210° C. and 220° C., respectively. The three extruders fed into a 203 mm (8″) wide vane die fitted with an A-B-C-B-A selector plug. The vane die and selector plug were sold by the Cloeren Company. The die temperature was set to 230° C.

The molten five layer co-extrusion exiting the die was quenched between a 203 mm (8″) diameter chrome casting roll and a 127 mm (5″) diameter nip roll. Both casting and nip roll were cored for water cooling. The quenched and polished sheet was wound up on 76 mm (3″) diameter paper cores. The casting and winding unit was built by Killion-Davis Std. Sheet thicknesses were 0.69-0.76 mm.

The adhesion between the barrier layer and the structural layer using tie layer to was verified and is summarized in Table 3.

TABLE 3
Adhesion Strength of Tie Layers in 5 Layer Coextruded Sheets

| A Layer - | | C Layer - | Mean |
|---|---|---|---|
| Structural | B Layer - Tie | Barrier | Average Peel |
| Layer | Layer | Layer | Force (lbf/in) |
| HDPE-S-N | Fusabond ® N525 | PTF | 8.781 |
| HDPE-S-N | Bynel ® 21E533 | PTF | 2.147 |
| HDPE-S-N | Bynel ® E418 | PTF | 7.856 |
| HDPE-S-N | Bynel ® 22E999 | PTF | 6.022 |
| HDPE-S-N | Elvaloy ® AS | PTF | 0.503 |
| HDPE-S-N | Bynel ® 41E754 | PTF | 0.329 |

All of the above tie-layers tested provide good adhesion between the barrier layer and the structural layer in the multi-layer structures prepared using co-extrusion, though some are better than others.

The extruded five-layer structure with PTF as the barrier layer was analyzed for permeation towards CM15 hydrocarbon fuel mixture, and the results are summarized in Table 4.

TABLE 4
CM15 Permeation rates for Multi-Layer films

| | | | CM15 Composition - % (MeOH/-Iso- | | | |
|---|---|---|---|---|---|---|
| | | | octane/Toluene): 15/42.5/42.5 | | | |
| | | Total | MeOH | Iso-Octane | Toluene | Total |
| | Multi-layer | Thickness | (g-mm/m²- | (g-mm/m²- | (g-mm/m²- | (g-mm/m²- |
| Sample | Composition | (mm) | day) | day) | day) | day) |
| Example 6 | PTF/Bynel ® | 0.441 | 0.2109 | 0.0002 | 0.0045 | 0.2157 |
| | 21E533/HDPE | | | | | |
| Comparative | PP/Bynel ® | 0.703 | 4.730 | 0.799 | 10.249 | 15.779 |
| Example C | 50E662/EVOH/ | | | | | |
| | Bynel ® 50E662/PP | | | | | |

Table 4 shows that three-layer structure of PTF with Bynel as the tie layer and HDPE as the structural layer shows better permeation barrier to CM15 fuel as compared to five-layer structure with EVOH as the barrier layer, where the three-layer structure with PTF was placed with PTF facing the fuel. The total permeation rate of the three-layer structure of Example 6 with PTF as the barrier layer is higher (0.2157 g-mm/m²-day) as compared to monolayer PTF of Example 1 (0.0108 & 0.0122 g-mm/m²-day) due to the calculation of permeation rate being based on the overall thickness of the multi-layer sheet, where the HDPE and tie-layer are not expected to contribute to the barrier of the structure.

What is claimed is:

1. A multilayer structure comprising:
a. a hydrocarbon fuel permeation barrier layer comprising a furan-based polyester, wherein the furan-based polyester is derived from:
i. 2,5-furan dicarboxylic acid or a derivative thereof,
ii. a C₂ to C₁₂ aliphatic diol or a polyol, and
iii. optionally at least one of a polyalkylene ether glycol (PAEG), a polyfunctional acid or a polyfunctional hydroxyl acid;
b. a first structural layer, wherein the first structural layer comprises at least one of a polyolefin, a polyester, or a polyamide; and
c. a first tie layer interposed between the barrier layer and the first structural layer, wherein the first tie layer comprises an ethylene based copolymer,
wherein the hydrocarbon fuel permeation barrier layer has a thickness in the range of 0.5-50% of the total thickness of the multilayer structure to provide a permeation barrier to a hydrocarbon fuel.

2. The multilayer structure of claim 1 further comprising a second structural layer wherein the barrier layer is interposed between the first tie layer and the second structural layer.

3. The multilayer structure of claim 2 further comprising a second tie layer wherein the barrier layer is interposed between the first tie layer and the second tie layer, and wherein the first tie layer comprises an ethylene based copolymer.

4. The multilayer structure of claim 1, wherein the furan-based polyester is poly(trimethylene furandicarboxylate).

5. The multilayer structure of claim 1, wherein the barrier layer further comprises poly(trimethylene furandicarboxylate) (PTF), such that the furan-based polyester is different from PTF and wherein the furan-based polyester and PTF forms a polymer blend comprising 0.1-99.9% by weight of PTF, based on the total weight of the polymer blend composition comprising the furan-based polyester and PTF.

6. The multilayer structure of claim 1, wherein the barrier layer further comprises poly(alkylene terephthalate) (PAT), wherein the furan-based polyester and PAT forms a polymer blend comprising 0.1-99.9% by weight of PAT, based on the total weight of the polymer blend comprising the furan-based polyester and PAT.

7. The multilayer structure of claim 6, wherein the barrier layer comprises poly(trimethylene furandicarboxylate) (PTF) and poly(ethylene terephthalate) (PET).

8. The multilayer structure of claim 1, wherein the multilayer structure is in a form of a housing provided with a port for introducing a hydrocarbon fuel in an enclosure defined by the housing.

9. The multilayer structure of claim 1, wherein the multilayer structure is in a form of a hollow body selected from a group consisting of a hose, a pipe, a duct, a tube, a tubing or a conduit.

10. An article for storage or transport of a hydrocarbon fuel comprising the multilayer structure of claim 1 in a form of a housing provided with a port for introducing hydrocarbon fuel in an enclosure defined by the housing, wherein the multilayer structure provides permeation barrier to the hydrocarbon fuel.

11. The article of claim 10 further comprising means for closing the port, such that upon closing the port, the material is isolated from the outside environment.

12. The article of claim 10, wherein the hydrocarbon fuel comprises one or more of ethanol, methanol, butanol, toluene, xylene, isooctane, gasoline, kerosene, liquefied petroleum, diesel and biodiesel.

13. The article of claim 10, wherein the article is in a form selected from the group consisting of a fuel container, a fuel container with a lid, a fuel container with a closure, a fuel canister, a fuel valve, a fuel inlet, a fuel filler neck, a fuel tank and a fuel line.

14. A method of reducing hydrocarbon fuel permeation through a fuel tank comprising providing a fuel tank having at least one polymeric barrier layer, wherein the polymeric barrier layer comprises furan-based polyester, wherein furan-based polyester is derived from:
a) 2,5-furan dicarboxylic acid or a derivative thereof,
b) a C₂ to C₁₂ aliphatic diol or a polyol, and
c) optionally at least one of a polyalkylene ether glycol (PAEG), a polyfunctional acid or a polyfunctional hydroxyl acid.

15. A method of storing or transporting a hydrocarbon fuel comprising providing a housing with a port for introducing the hydrocarbon fuel in an enclosure defined by the housing, wherein the housing comprises furan-based polyester, wherein furan-based polyester is derived from:
a) 2,5-furan dicarboxylic acid or a derivative thereof,
b) a C₂ to C₁₂ aliphatic diol or a polyol, and
c) optionally at least one of a polyalkylene ether glycol (PAEG), a polyfunctional acid or a polyfunctional hydroxyl acid.
